(19) United States
(12) Patent Application Publication
(10) Pub. No.: US 2005/0075809 A1
(43) Pub. Date: Apr. 7, 2005

(54) Apparatus and method for detecting, filtering and conditioning AC voltage signals

(75) Inventors: Michael Bailey, Brick, NJ (US); John Brown, Lakewood, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: EWC Controls Incorporated, Englishtown, NJ (US)

(21) Appl. No.: 10/664,396

(22) Filed: Sep. 18, 2003

(51) Int. Cl. G06F 19/00

(52) U.S. Cl. 702/64

(57) ABSTRACT

An interface circuit for detecting, filtering and conditioning alternating current (AC) voltage input signals from external controllers to be received by a microcontroller. Coupled between the outputs of the external controllers and the inputs of the microcontroller of the interface circuit are RS232 receivers, which are used to detect and condition AC voltage input signals. A voltage divider having specific value resistors may be coupled between the outputs of the external controllers and the inputs of the RS232 receivers to reduce the operational voltage to a narrow detection range, the combination allowing the microcontroller to interpret the status of the AC voltage input signal.

### BACKGROUND OF THE INVENTION

This invention relates generally to an apparatus and method for detecting, filtering and conditioning electrical signals and more particularly to an interface circuit for detecting, filtering and conditioning alternating current (“AC”) voltage input signals from external controllers, which may be coupled to a microprocessor and its associated peripherals, or a microcontroller circuit, which may include such peripherals built-in.

Microprocessor-based controller circuits are known. A microcontroller is a term commonly used to describe a component that includes a microprocessor as well as built-in peripherals. Such peripherals may include but are not limited to the following: RAM, ROM, I/O AD, TimerCounter, and the like.

These microcontroller circuits are often employed to detect and respond to input signals from external controllers such as, for example, manual and automatic switches, relay contacts, temperature and humidity controllers (e.g., thermostats) and the like. These external controllers and microcontrollers may be part of an overall electromechanical system such as a heating, ventilation and air conditioning (“HVAC”) microcontrolled system.

For example, in a given microcontrolled HVAC system, if a thermostat senses a temperature drop in a given area, it responds by activating a switch of some sort (e.g., closing or opening a switch), which in turn couples an input control signal to a microprocessor to activate a furnace system, for instance. This input or control signal will first likely be received at an interface circuit, which may or may not be part of the microcontroller circuit. The interface circuit may condition the input signal and then send it to an input terminal on the microcontroller. The microcontroller will then, in turn, control a relay switch to activate the furnace or other load. In this example, the furnace may begin operating to produce heat and deliver it to the area where requested.

When microprocessors are referred to in this specification, it should be understood by one of ordinary skill in the art that, where appropriate, any discussion regarding microprocessors applies to microcontrollers and vice versa, as a microcontroller typically includes at least a microprocessor along with built-in peripherals.

Microcontrollers typically detect input signals where those input signals are within a certain direct current (“DC”) voltage range. For example, known microprocessors respond to DC voltage levels at around 5 VDC. Others respond to DC voltage levels at around 12 VDC. Still others respond to various voltage levels between 5 VDC and 12 VDC. If an AC voltage signal has not been conditioned appropriately (i.e., converted to a smooth DC voltage signal), electrical noise is associated with the AC input signal, there may be occasions when a microprocessor or microcontroller responds in an inappropriate manner.

For example, in an HVAC system controlled by a microcontroller, an AC voltage input signal detection interface circuit may be susceptible to errors in detecting AC voltages and converting them to DC logic voltage levels. This may be due, in part, to spurious electrical noises received either at an input node to an interface or at an input node to the microprocessor, where under this scenario the spurious electrical noise has passed through the interface circuit to the input terminal of the microprocessor.

Spurious electrical noise can be caused by, for example, voltage dips and spikes created by an external controller's contact switches closing and opening. Other spurious electrical noises may be caused by AC line data communications, as well as natural causes such as lightening storms.

Known microcontrollers are susceptible to errors in detecting AC voltage input signals due to these and other types of spurious noises or distortion. These electrical noise sources impose distortion on sinusoidal AC voltage signals that not only causes errors in detecting input states but can also carry enough energy to destroy the detection circuit as well.

Known methods for detecting input signals from external controllers use conventional interface circuits and conventional filtering to convert an AC voltage input signal to a microprocessor logic operating voltage level. These known circuits, however, lack the repeatable threshold and hysteresis needed to accurately and consistently detect and decipher an AC voltage input signal from an external controller where there may be noise on the line. Known interface circuits also cannot cope well with peak bursts of energy and other spurious noises typically associated with AC voltage sources. Known interface circuits for microcontrollers do not commonly provide a non-distorted AC load to the AC voltage source.

For example, FIG. 1 is a schematic illustration of a typical prior art interface circuit for conditioning an AC voltage input signal. The circuit 10 employs a first resistor 12 (R1) and a second resistor 16 (R2), which together operate as a voltage divider. With the resistor values given in this exemplary circuit, namely, 2.4K ohms (R1) and 1K ohms (R2) (both rated at 1 Watt), and an input source voltage of 24 VAC root mean square (“RMS”) (peak voltage of 34 volts), the logic DC voltage measured across node A to ground is approximately 10 volts.

The diode 14, placed in the interface circuit after the first resistor 12, rectifies the sinusoidal AC voltage input signal. An avalanche or Zener diode 18 is placed in parallel with a capacitor 20 in the circuit 10. A main function of the Zener diode 18 is to limit the peak voltage value in accordance with the rated voltage level set by the Zener component. For example, if the Zener diode 18 is rated at 5 volts, the peak voltage at node A will generally not exceed +5 volts. After such level, the Zener diode 18 acts as a current sink.

The capacitor 20 is valued at 47 μF to have a duty cycle in combination with the second resistor 16 (1K ohm) of approximately 0.04 seconds. The capacitor 20, in conjunction with the Zener diode 18 and the second resistor 16, convert the AC input signal into a conditioned input signal or digital pulse. The microprocessor 22 interprets or detects the input signal as a command signal from the input. Thus, provided distortion or other spurious noises are absent, the AC voltage input signal would ideally be converted into a smooth DC voltage or microprocessor logic operating voltage level, allowing the microprocessor to detect the input signal and respond accordingly.

In operation, when the thermostat (not shown) is activated, e.g., it closes its switch, a 24 VAC input signal is generated at the input 19 of the circuit 10. The voltage signal is then rectified by the diode 14 and divided by resistors 12 and 16 such that its value is approximately 10 volts between node A and ground, as shown in FIG. 2A. This rectified and voltage divided input signal is coupled across the Zener diode 18 and the capacitor 20.

As illustrated in FIG. 2B, the capacitor will begin charging from zero to 10 volts. However, assuming the Zener diode 18 is set to turn on at 5 volts, when the potential across the capacitor 20 reaches 5 volts, the Zener will clamp the input signal at approximately 5 volts. A digital signal (e.g., a logical “1”) is thus produced and coupled to the microprocessor 22, which in turn couples a digital input command signal to the load, for instance, a furnace (not shown) and commands it to turn on.

Here, the Zener diode 18 voltage, the voltage across the load resistor 16, is Vdd or +5V in this particular example. The Zener diode current is Iz. The Zener diode 18 will then attempt to regulate the load voltage against variations in load current and against variations in supply voltage V (in this case, the AC voltage input signal received from an external controller).

Moreover, as load current or AC input voltage changes or varies, the Zener diode 18 current Iz will attempt to accommodate these changes to maintain a nearly constant load voltage. As the capacitor 20 is charging, Ic exceeds Iz and thus reduces the amount of current flowing to the Zener diode 18. When the capacitor 20 is fully charged, Ic is at a relative minimal and Iz is at a relative maximum. Therefore, the current Iz approaches current I as the Zener diode 18, at its threshold voltage, sees almost all the current from the rectified AC input signal.

If, at this time, the thermostat's switch is opened, the AC voltage input signal approaches zero volts. The second resistor then begins to pull current off the capacitor 20, subsequently discharging it. Once the potential across the capacitor drops below the Zener diode threshold, the Zener 18 “turns off” and significantly reduces the amount of current coupled through it. Around this same time, the microprocessor is ideally sensing a signal loss, which it interprets as a logical “0”. Once the “0” is detected, the microprocessor sends a command signal to turn the furnace off. The circuit 10 returns back to its initial state.

Conventional interface circuits, like the one depicted and described with reference to FIGS. 1, 2A and 2B, have several disadvantages. Two of the most significant disadvantages include very low hysteresis and a minimum over voltage protection for the microcontroller.

With respect to a low hysteresis, a typical microcontroller input is not Schmitt triggered. Having hysteresis allows for an input to a microprocessor to be capable of handling slow rising or falling signals. The microprocessor's internal input circuit expects the input signal to be either a logical one or logical zero. In most cases, at some point in a voltage input signal, a voltage region exists where it represents neither a one nor a zero. As the input signal changes state from one to zero, it passes through this non-defined or non-detectable state. In most instances, this state change is fast and not recognizable by the microprocessor to cause a problem.

If, on the other hand, the change is relatively slow, as in the circuit depicted in FIGS. 1, 2A and 2B, perhaps because of a relatively slow discharging capacitor in an RC filter network, the microprocessor's internal input circuit may have problems interpreting the state of the signal. As the input voltage is falling, the input circuit will go through a phase of internal over-current and oscillation as it tries to determine or define the input as a logical one or a zero.

Any fluctuation in the AC voltage input signal received by the circuit of FIG. 1 might be realized and reflected by the Zener diode 18 and the capacitor 20, causing a very unsteady state for the converted DC logic signal coupled to the microprocessor 22. Without relatively high hysteresis, instead of a smooth square wave as shown in FIG. 2B, the digital voltage value will likely fluctuate around 5 volts (in this example), causing the microprocessor to likely malfunction, not knowing whether it is receiving a logical one or logical zero input signal.

With respect to over-voltage protection, often Zener diodes are used as voltage clamps. Theoretically, they will start to conduct current if the voltage across the device equals its “Zener” voltage. However, the Zener voltage is actually affected by the current going through it. With little current passing through the Zener diode, it will leak (i.e., conduct) current even if the voltage is lower than the Zener voltage threshold. As the current goes up, the Zener threshold voltage also goes up.

Known microcontrollers that use a Zener diode as a clamping device for input protection on a microprocessor experience a point where the excess current passing through the Zener diode as it clamps the input will allow the microprocessor input voltage to go out of range. Excessive current through the Zener diode depends upon the series resistors between the input and the Zener diode and the voltage of the input.

One major disadvantage in using a Zener diode clamp to protect the microprocessor is when the microprocessor is not powered up. If the microcontroller receives an active input while the microprocessor is not powered up, the microprocessor will have substantial input current and voltage to cause what is commonly referred to as CMOS latch up. As a result, the microprocessor will be damaged or malfunction. In addition, if there is an over voltage situation, the Zener diode 18 may break down and not be able to protect the microprocessor 22 from such power surges. Thus, another disadvantage of known microcontrollers is an inability to accurately and consistently interpret AC voltage input signals received from external controllers, such as thermostats and the like.

Accordingly, it would be desirable to have methods and apparatus for improved AC voltage signal detection interface circuits having better hysteresis and over-voltage protection.

### SUMMARY OF THE INVENTION

The present invention is directed to an apparatus and method for detecting AC voltage input signals from external controllers such as, but not limited to, manual and automatic switches, relay contacts, temperature and humidity controllers. For purposes of convenience and clarity, the term “thermostat” is used in this context to mean any external controller, including those mentioned previously as well as any equivalents not mentioned or ones hereinafter developed, all being contemplated and covered herein by the present invention. Equally, the use of an HVAC system as an example of a system controlled by the microcontroller is meant to cover any system that may be controlled by external controllers and microcontrollers. Use of an HVAC system as an example is not meant to be limiting in any way. All equivalents and variations known now or in the future to those of ordinary skill in the art are contemplated by the present invention.

In accordance with one or more aspects of the present invention, there is provided an interface circuit, comprising at least one microprocessor operable to perform one or more functions. The microprocessor comprises at least a time input terminal for receiving a time reference signal and a signal input terminal for receiving an input signal within a detectable microprocessor logic operating level. This aspect further comprises at least one RS232 receiver having an input for receiving an AC voltage input signal and an output for transmitting a microprocessor logic operating voltage signal, the output of said at least one RS232 receiver being coupled to said signal input terminal of the microprocessor. The circuit further comprises at least one time reference RS232 receiver having an input for receiving a constant time reference AC voltage signal and an output for transmitting a time reference voltage signal to the time input terminal of the microprocessor.

In a preferred embodiment, the interface circuit comprises a voltage divider coupled to the at least one time reference RS232 receiver to reduce the amplitude of the incoming operational voltage to within a detectable range. The interface circuit preferably further comprises a voltage divider coupled to the at least one RS232 receiver to reduce the amplitude of the incoming operational voltage to within a detectable range. Preferably, the falling edge of the time reference signal is capable of interrupting the microprocessor. More preferably, during interruption of the microprocessor, a sampling or reading is taken at the input of the at least one RS232 receiver to determine if an external controller has been activated. Most preferably, the voltage divider is designed as such that the incoming operational voltage is between about 0 volts and 5 volts.

Preferably, the interface circuit further comprises an input logic high threshold voltage and an input logic low threshold voltage. More preferably, the resistor values are set such that the incoming operational input logic high threshold voltage is between about 1.3 volts and 2.7 volts and said input logic low threshold voltage is between about 0.5 volts and 1.9 volts. Most preferably, the resistor values are set such that the incoming operational input logic high threshold voltage is about 2.1 volts and the incoming operational logic low threshold voltage is about 1.1 volts.

In a preferred embodiment of the interface circuit, the input signal of the at least one RS232 receiver is coupled to an external controller. The external controller may comprise any one of a thermostat, switch, relay contact, a humidity controller, or the like.

In accordance with another embodiment, the interface circuit includes a failsafe interface control circuit coupled between an output terminal of an external controller and the input of the at least one RS232 receiver. The failsafe interface control circuit is capable of minimizing microprocessor malfunctioning.

In accordance with another aspect of the present invention, there is provided a method for detecting an AC voltage input signal, comprising providing an interface circuit including at least two RS232 receivers, each being coupled to a respective input of a microprocessor. The method further comprises splitting a received source signal into a first and second signal. The first signal is coupled to a time reference circuit. The time reference comprises one of the at least two RS232 receivers. The second signal is coupled to at least one external controller circuit. The external controller circuit includes at least one of the at least two RS232 receivers. Further, the method comprises detecting the first signal at the time reference circuit output, interrupting the microprocessor, and sampling the output of the at least one external controller circuit after a predetermined delay from interrupting the microprocessor.

Preferably the method comprises a plurality of external controller circuits. More preferably, if a signal is detected during the sampling step, the method further comprises activating a controller circuit to perform a predetermined function. Most preferably, the predetermined function is to activate a load circuit. The step of activating a controller circuit comprises activation of one of a relay, a switch and a driver circuit.

### DESCRIPTION OF THE FIGURES

For the purposes of illustrating the invention, the drawings show forms that are presently preferred, it being understood, however, that the invention is not limited to the precise arrangements and instrumentalities shown, in which:

FIG. 1 is a schematic illustration of a prior art interface circuit;

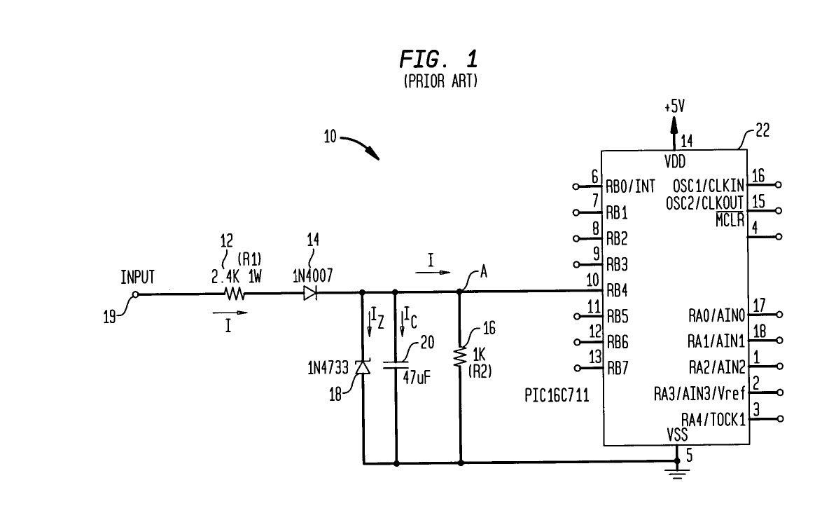

FIG. 2A is a graph illustrating voltage plotted against time as a characteristic of the circuit of FIG. 1 after an AC voltage input signal has been rectified by the diode shown in FIG. 1;

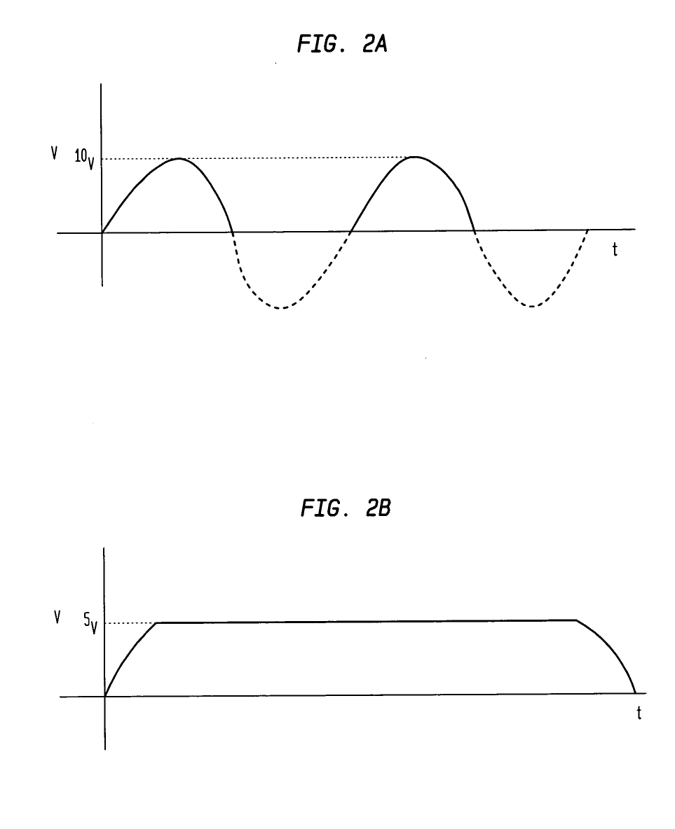

FIG. 2B is a graph illustrating voltage plotted against time of an AC voltage input signal as a characteristic of the circuit of FIG. 1 during the charging of the capacitor and the clipping of the peak voltage by the Zener diode after the signal has been rectified as shown in FIG. 2A;

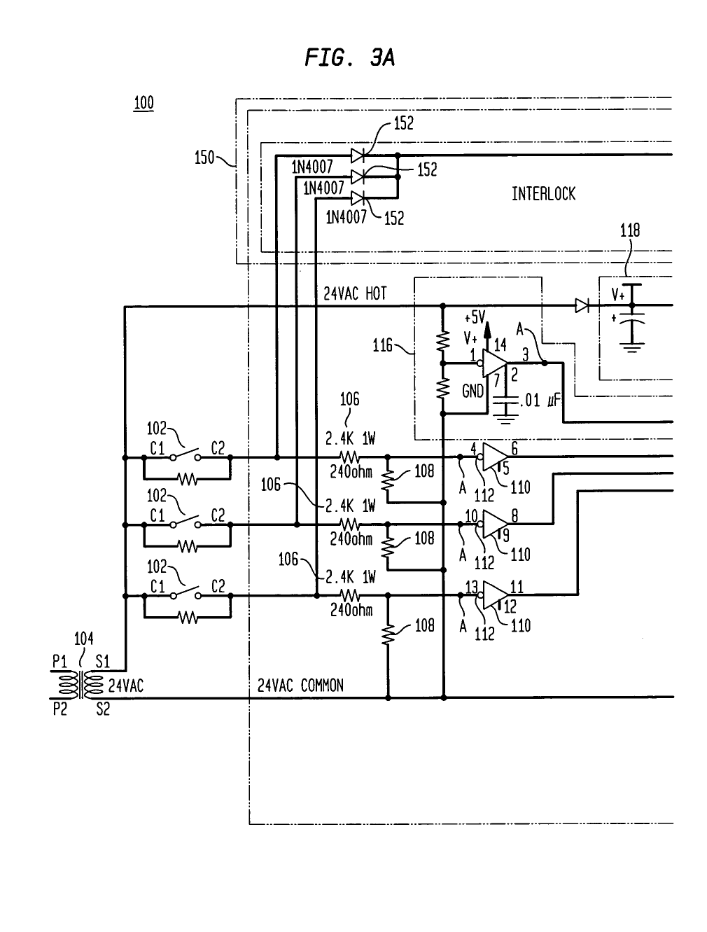

FIGS. 3A and 3B are two parts of a schematic illustration of an interface circuit in accordance with one or more aspects of the present invention; and

FIGS. 4A-4C are graphs illustrating voltage plotted against time at various stages of a signal as it travels through the interface circuit illustrated in FIGS. 3A and 3B.

### DESCRIPTION OF PREFERRED EMBODIMENTS

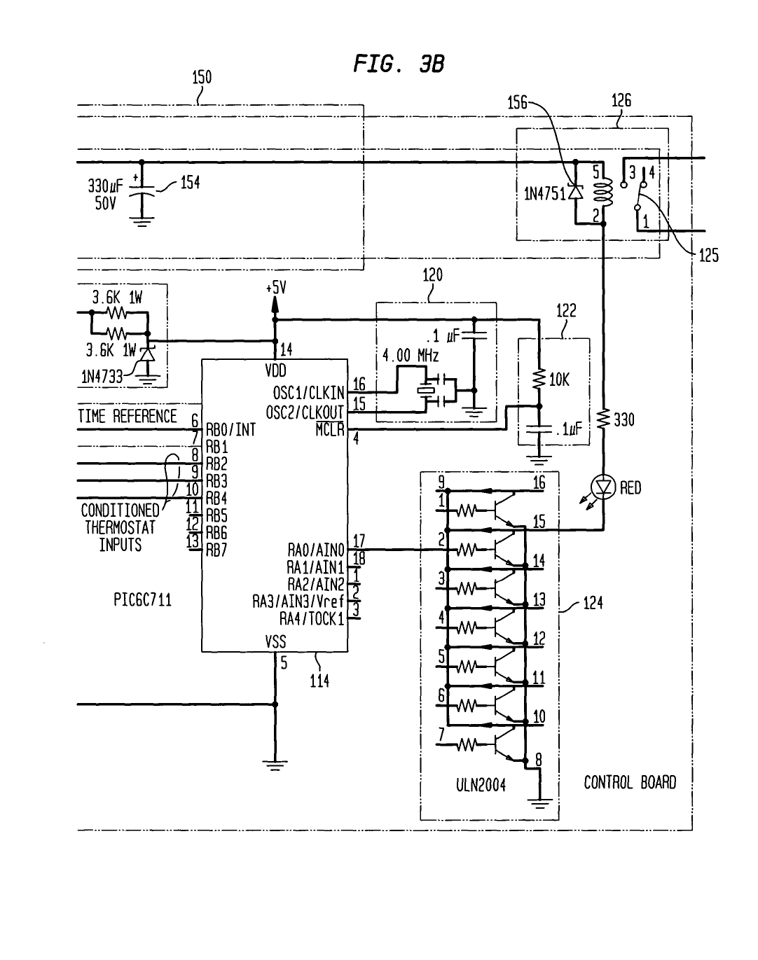

Referring now to the drawings, wherein like numerals indicate like elements, there is shown in FIGS. 3A and 3B, an AC voltage signal detection interface circuit 100 in accordance with one or more aspects of the present invention. The interface circuit 100 includes a plurality of electromechanical or electronic temperature control thermostats 102 represented by switches having contacts C1, C2 and powered by, in this example, 24 VAC. The 24 VAC is outputted from a step down transformer 104, which is coupled to a residential or commercial regulated power source (not shown) such as an outlet receptacle (not shown) providing 220 or 110 VAC RMS. That is, the 24 VAC transformer can be powered by 110 VAC or 220 VAC or any other possible line voltages. It is not important as to the source of power, except to the extent that the microcontroller circuit receives 24 VAC. Although FIGS. 3A and 3B depict thermostats as the external controllers, it should be understood by one of ordinary skill in the art that the thermostats can be substituted with any and all other external controllers such as, but not limited to, manual and automatic switches, relays contacts, and humidity controllers.

Also, it is worth noting that not all thermostats electrically act as on/off switches. For example a bi-metallic cooling thermostat contemplated by the present invention may have a resistor across its contacts. Often, the resistor will have a value of about 3.6K ohms. The purpose of the resistor is to act as an “anticipator” for the thermostat. That is, when the contact is open, voltage will be imposed across the resistor. It will dissipate heat and prompt the thermostat to close its contacts a bit earlier than it normally would have. This is why it is commonly referred to as an “anticipator.”

This function may work fine in an application where the thermostat energizes a large load or coil to start an air-conditioning compressor. However, if this thermostat is attached to an electronic board of any sort, it may cause problems. The electronic board has to source enough current into the 3.6K-ohm resistor for it to anticipate without sensing the load from the 3.6K-ohm resistor as if it were a closed switch.

Embodiments of the present invention minimize this issue. Using the values of 800-ohms series resistors and 82-ohm shunt resistors, the input circuits described herein have an input resistance of 882 ohms. A 3.6K-ohm anticipator resistor can pull the input signal to a maximum of about 8 volts. That is far below the high threshold. Thus, the anticipator has minimal or no affect, yet enough current is passing through it to cause the expected thermal reaction.

Each thermostat 102 is coupled, by way of a voltage divider set of resistors 106, 108, (R1, R2), respectively, to an RS232 receiver 110. At node A, through the voltage divider set, the voltage present at the input to the RS232 is reduced to within a detectable range of the RS232 . Included at the input of the RS232 receivers is an inverter 112 for inverting the voltage of the incoming AC voltage signal.

Each RS232 receiver 110 is coupled to an input terminal of a microprocessor 114. Although only three sets of thermostats, voltage divider circuits and RS232 receivers are shown in FIGS. 3A and 3B, it should be understood that the microprocessor 114 is capable of detecting up to twelve (12) external controllers. It should also be understood that one or more processors, which are capable of receiving more than twelve (12) input signals from external controllers, might replace the microprocessor 114 and be capable of handling more than twelve input signals.

In addition to each thermostat 102 being coupled to the microprocessor 114, via the voltage divider circuit and the RS232 receivers 110, the same 24 VAC source voltage is fed to a time reference circuit 116, which comprises a voltage divider circuit coupled to an RS232 receiver 110, which in turn is coupled to the microprocessor 114.

The RS232 receivers are advantageously configured and arranged within the circuit 100 to detect AC voltage input signals while filtering and conditioning the signal so that the microprocessor 114, and related components, can accurately and consistently detect the status of the AC voltage input signal. Preferred embodiments of the present invention provide for a cost effective, robust and a quite accurate interface control circuit with improved interference immunity. The RS232 used in the exemplary circuit 100 may be any conventional RS232 receiver. For example, an acceptable RS232 receiver for use in the circuit 100 is the QUAD RS232 Receiver 75C189 14P (DS14C189) available from JDR Microdevices, located San Jose, Calif.

Downstream from the time reference circuit 116 is a regulator circuit 118 for providing regulated voltage to the microprocessor 114 and to a clock circuit 120, which is also coupled to the microprocessor. The clock circuit runs the internal clock of the microprocessor 114. A reset circuit 122 is also provided to initiate the microprocessor 114 when necessary prior to receiving an input signal.

Coupled to pin 17 of the microprocessor 114 in FIGS. 3A and 3B is a semiconductor driver circuit 124 for pulling down 24 VDC to activate a relay 125 in the relay circuit 126. The relay 125 is coupled to a load (not shown) such as a furnace. Although a relay circuit 126 is shown, the AC voltage input control circuit 100 is capable of controlling any and all electromechanical devices, such as but not limited to, alternating or direct current motor windings, solenoids and starter coils.

An alternative to the circuit 100 configuration, as shown in FIGS. 3A and 3B, is a circuit that includes what has been discussed above as a failsafe interface control circuit 150. The failsafe interlock control circuit 150 is also capable of controlling one or more of the electromechanical devices mentioned above, namely, but not limited to, alternating or direct current motor windings, relays, solenoids and starter coils. The inclusion of the failsafe interlock control circuit 150 provides for processor independent detection and response to input signals from external controllers.

In other words, if a request is made to raise the indoor temperature in a house or building zone, the AC voltage input control device must rely upon the proper performance and operational integrity of the microprocessor 114 to perform the requested function. In the event the microprocessor 114 malfunctions or locks up, the function can remain active, resulting in continuous activation of the requested function (i.e., running the furnace to provide heat to the requesting zone.) This may occur even after the controller has ceased to request the function, which could lead to an unsafe condition.

The failsafe interlock control circuit 150 couples the input signal from the external controllers to allow operation of the requested function. Thus, the requested function cannot occur or be performed unless the controller request exists. The AC voltage input circuit microprocessor 114 will always then default to the “off” position or what is considered the “failsafe” condition of the controlled device or system, in the event of a microprocessor malfunction.

The failsafe interlock control circuit 150 guarantees that a control output will occur only if a requested input is active. This prevents an abnormal condition of the microprocessor energizing an output, without a logical input allowing it to energize. In short, this failsafe interlock control circuit prevents a runaway condition in which a microprocessor failure results in continuous activation of the controlled system or device.

In operation, as shown in FIGS. 3A and 3B, the circuit 100, preferably includes a 24 VAC source, which supplies AC voltage to the thermostats as well as the time reference circuit 116 and the regulator circuit 118.

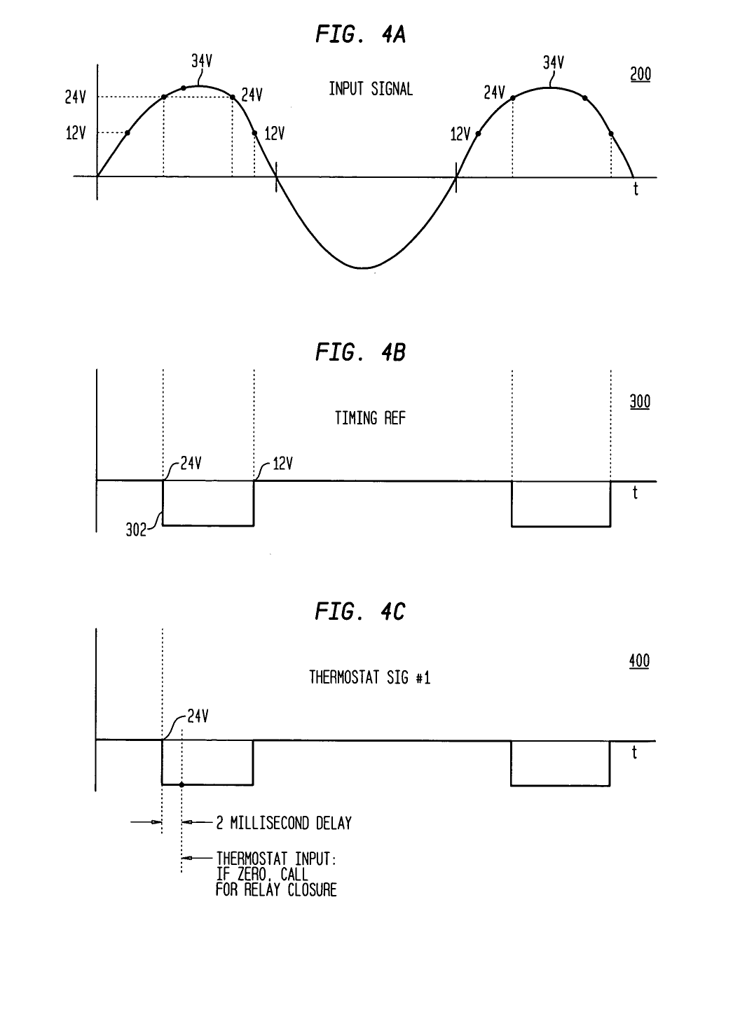

As best shown in FIG. 4A, a sinusoidal AC voltage source 200 is shown. In this particular embodiment, the source power comprises 24 VAC RMS, with a peak voltage of approximately 34 volts. As best shown in FIG. 4B at the output of the RS232 of the timing circuit 116 (node A), a timing wave 300 is shown. Because the RS232 acts as an inverter, the digital signal goes low when the source voltage of 24 VAC reaches approximately 70% of its final crest value of 34 Volts (peak), which is about 24 Volts. The negative pulse will continue until the source voltage 24 VAC reaches approximately 12 Volts. This allows for approximately a 10 to 12 volt hysteresis.

It should be appreciated by one of ordinary skill in the art and is contemplated by the present invention that, although the circuit shown in FIGS. 3A and 3B includes an RS232 receiver that, by its nature, is an inverter of the input signal, another embodiment within the scope of the present invention includes RS232 receivers without the inverter feature. Therefore, whereas the timing circuits shown in FIGS. 4A-C reflect negative pulses, another of many embodiments may include positive control pulses as well.

As shown in FIGS.4A-C, the falling edge of the timing signal 302 interrupts the microcontroller 114. The interrupt routine samples the conditioned thermostat input after about a 2-millisecond delay as shown in FIG. 4C. The delay insures that the input will be valid. That is, the microprocessor 114 looks to the signal coming in from the one or more of the RS232 receivers feeding their output to the microprocessor from the thermostats 102. If the microprocessor samples a negative pulse, it will treat that as a thermostat switch in the closed position and activate the relay circuit 126 to close. This will, in turn, activate the load, for example, turning on a furnace. Concurrent with sending a signal to the relay circuit 126, the microprocessor 114 sends a signal to the driver circuit 124 to pull down the 24 VDC of the relay circuit 126, causing the relay switch to go from position 4 to position 3 as shown in FIGS. 3A and 3B.

In an alternative embodiment, where the failsafe interlock control circuit 150 is included, when one or more of the thermostat switches close(s), the 24 VAC signal is also coupled to the failsafe interlock control circuit 150. Here, as best shown in FIGS. 3A and 3B, the signal is rectified by diode 152 and conditioned into a clipped DC signal through the capacitor 154.

As mentioned previously, this failsafe interlock control circuit 150 provides for protection of the HVAC system. Specifically, if the microprocessor 114 fails, the failsafe interlock control circuit 150 will cause the relay 126 to open and prevent a runaway situation with the furnace pumping heat where no heat is needed. It should be noted that the Zener diode 156 across the relay 126 performs a dual function. One primary function is to clamp the reverse pulse that occurs when a relay driver opens and the relay relaxes. A second function is to protect the relay coil from excessive voltage.

In the embodiment shown in FIGS. 3A and 3B, then, RS232 output signals will go low when the AC input is 24 VDC. This is about 70% of the final crest value of the 24 VAC signal. The RS232 receiver output will go high when the AC input is 12 VDC. The hysteresis of approximately 10 volts provides for sufficient noise immunity.

In a very specific example, a receiver input signal for an RS232 receiver utilized in preferred embodiments of this invention includes an absolute maximum input voltage of ±30 volts. This signal is built out with a 10/1 voltage divider, which becomes ±300 volts. The input high threshold ranges from between about 1.3 volts (minimum) and 2.7 volts (maximum). The input high threshold is typically 2.1 volts. The input low threshold ranges from about 0.5 volts minimum to about 1.9 volt maximum and is typically about 1.1 volts.

Thus, at least one of many advantages of the present invention over known systems and methods is the use of an interface circuit including RS232 receivers, which are capable of accepting input voltages regardless of whether the receivers are powered up or not. The RS232 receivers cannot couple any out of range voltage to the microprocessor because they have the same power source.

As an example of another of many advantages, the present invention contemplates interface circuits including RS232 receivers, which are capable of accepting non-defined input values without damage to the microprocessor.

Although the invention herein has been described with reference to particular embodiments, it is to be understood that these embodiments are merely illustrative of the principles and applications of the present invention. It is therefore understood that numerous modifications may be devised without departing from the spirit and scope of the present invention as defined by the appended claims.

1. An interface circuit, comprising:
at least one microprocessor operable to perform one or more functions, said microprocessor including at least a time input terminal for receiving a time reference signal and a signal input terminal for receiving an input signal within a detectable microprocessor logic operating level;
at least one RS232 receiver having an input for receiving an AC voltage input signal and an output for transmitting a microprocessor logic operating voltage signal, the output of said at least one RS232 receiver being coupled to said signal input terminal of said at least one microprocessor; and
at least one time reference RS232 receiver having an input for receiving a constant time reference AC voltage signal and an output for transmitting a time reference voltage signal to said time input terminal of said at least one microprocessor.

2. The interface circuit of claim 1, further comprising a voltage divider coupled to said at least one time reference RS232 receiver to reduce the incoming operational voltage to within a detectable range.

3. The interface circuit of claim 1, further comprising a voltage divider coupled to said at least one RS232 receiver to reduce the incoming operational voltage to within a detectable range.

4. The interface circuit of claim 1, wherein the falling edge of the time reference signal is capable of interrupting said at least one microprocessor.

5. The interface circuit of claim 4, wherein during interruption of said at least one microprocessor, a reading is taken at the input of said at least one RS232 receiver to determine if an external controller has been activated.

6. The interface circuit of claim 2, wherein said voltage divider is arranged such that said incoming operational voltage is between about zero to five volts.

7. The interface circuit of claim 2, wherein said voltage divider comprises a pair of resistors having predetermined values such that said incoming operational voltage is between about 0.5 to 2.7 volts.

8. The interface circuit of claim 2, further comprising an input logic high threshold voltage and an input logic low threshold voltage.

9. The interface circuit of claim 8, wherein said resistor values are set such that said incoming operational input logic high threshold voltage is between about 1.3 to 2.7 volts and said input logic low threshold voltage is between about 0.5 to 1.9 volts.

10. The interface circuit of claim 8, wherein said resistor values are set such that said incoming operational input logic high threshold voltage is about 2.1 volts.

11. The interface circuit of claim 8, wherein said resistor values are set such that said incoming operational logic low threshold voltage is about 1.1 volts.

12. The interface circuit of claim 1, further comprising at least twelve RS232 receivers.

13. The interface circuit of claim 1, wherein the output signal of said at least one RS232 receiver is coupled to at least one external controller.

14. The interface circuit of claim 13, wherein said at least one external controller is selected from a group comprising a thermostat, a switch, a relay contact, and a humidity controller.

15. The interface circuit of claim 1, further comprising a failsafe interface control circuit coupled between an output terminal of an external controller and said input of said at least one RS232 receiver, whereby said failsafe interface control circuit is capable of minimizing microprocessor malfunctioning.

16. A method for detecting an AC voltage input signal, comprising:
providing an interface circuit including at least two RS232 receivers, each RS232 receiver being coupled to an input of a microprocessor;
splitting a received input signal into a first and second signal, the first signal being coupled to a time reference circuit, said time reference circuit including one of said at least two RS232 receivers, the second signal being coupled to at least one external controller circuit, said external controller circuit including at least one of said at least two RS232 receivers;
detecting said first signal at said time reference circuit output;
interrupting said microprocessor; and
sampling the output of the at least one external controller circuit after a predetermined delay from interrupting the microprocessor.

17. The method of claim 16, further comprising a plurality of external controller circuits.

18. The method of claim 16, wherein, if a signal is detected during the sampling step, the method further comprises activating a controller circuit to perform a predetermined function.

19. The method of claim 18, wherein the predetermined function comprises activating a load circuit.

20. The method of claim 18, wherein the step of activating a controller circuit comprises activation of one of a relay, a switch or a driver circuit.
